(19) United States
(12) Patent Application Publication
(10) Pub. No.: US 2007/0180050 A1
(43) Pub. Date: Aug. 2, 2007

(54) Systems, methods and computer program products for sharing three-dimensional body scan data

(76) Inventor: David A. Bruner, Cary, NC (US)

Correspondence Address: MYERS BIGEL SIBLEY & SAJOVEC, PO BOX 37428, RALEIGH, NC, 27627, US

(21) Appl. No.: 11/345,418

(22) Filed: Feb. 1, 2006

(51) Int. Cl. G06F 15/16

(52) U.S. Cl. 709/217

(57) ABSTRACT

A network includes a web site of an intermediary and web sites of respective product/service providers. A customer accesses a product/service provider web site, initiates a purchase transaction, and transmits body scan data to the product/service provider. The body scan data is generated by a third party having a body measurement system, but is owned and kept by the customer. Each product/service provider web site is configured to conduct a sales transaction with a customer in response to receiving body scan data from the customer, and to request a decryption key from the intermediary for decrypting the body scan data. Using information in the decryption key request, the intermediary identifies both who generated the body scan data and who the product/service provider is. The intermediary then pays revenues to the various third party body scan sites according to a predetermined formula and/or business arrangement.

### FIELD OF THE INVENTION

The present invention relates generally to custom clothing and, more particularly, to systems, methods and computer program products for providing custom clothing.

### BACKGROUND OF THE INVENTION

The apparel industry in the United States is moving towards utilization of high technology customer measurement techniques to help facilitate customer satisfaction with size-customized products or improved size and style selection from standard sized offerings. These new technologies for body measurement facilitate accurate acquisition of human body measurements very quickly. Traditionally, tailors and fitters have taken these measurements themselves for the same purposes. However, a tailor's measurements can be very inconsistent when compared with other tailors. An accurate reliable data set of the surface of the body of a person is needed in order to develop consistent body measurements. These new measurement techniques are also finding use in other industries which can utilize accurate body measurements and human models including medical, health and fitness, and entertainment and electronic gaming.

Several technologies have been developed for quickly and reliably obtaining body measurements, including two dimensional video silhouette imaging, laser-based scanning, and white light phase measurement. The white light phase measurement approach has proven to be a promising method of obtaining a full three-dimensional representation of the body of a person without the use and cost of lasers.

Unfortunately, many in the apparel industry have been somewhat slow to adopt these body measurement technologies. As such, it would be desirable to provide incentives to the apparel industry to adopt these new body measurement technologies.

### SUMMARY OF THE INVENTION

In view of the above discussion, methods, systems and computer program products for facilitating the use of body scan data in the buying and selling of products/services (e.g., apparel, physical fitness services, medical products and services, entertainment/gaming products and services, etc.) are provided. According to some embodiments of the present invention, a network includes a web site of an intermediary and one or more web sites of a respective one or more product/service providers. The intermediary manufactures and sells body measurement systems and has relationships with other manufacturers of body scanners and their customers. Embodiments of the present invention are designed to increase use and demand for body measurement systems manufactured and/or controlled by the intermediary (and by other manufacturers) and to increase the number of product and service providers using body scan data generated by these body measurement systems and, in doing so, generate revenue for the intermediary, owners of the body scanners, and for the product/service providers.

According to some embodiments of the present invention, a customer communicates with the intermediary web site and a product/service provider web site via a web client (e.g., a browser). For example, via a web client, a customer accesses a product/service provider web site, initiates a purchase transaction with the product/service provider, and transmits body scan data to the product/service provider. The body scan data is generated by a third party having a body measurement system (or the intermediary may also own body scanners that operate in the network), but is owned and kept by the customer. The third party body scan generator may or may not be connected to the network, at their option.

According to embodiments of the present invention, each product/service provider web site is configured to initiate a sales transaction (e.g., the sale of custom apparel, health/fitness evaluations, 3D avatars for games, or any existing or future commercial products/services which can leverage the information in body scan data, etc.) with a customer in response to receiving body scan data from the customer. Each product/service provider has a software tool provided by the intermediary which allows the product/service provider to open and utilize the encrypted body scan data from a customer body scan that the customer has transmitted to them. This software tool automatically obtains a decryption key from the intermediary web site allowing it to decrypt the body scan data received from the customer. This process (key retrieval and decryption) happens when the product/service provider opens the 3D body scan data set using the software tool provided by the intermediary. When this decryption key is obtained, the intermediary's web site is able to identify the third party that generated the body scan (via the information submitted requesting the decryption key) and logs that information and also the product/service provider who is accessing it. In the event the product/service provider is unable to connect to the network due to internet or network communications difficulties, the software tool also provides a physical “code” or number which allows the provider to phone or fax the intermediary to manually request a decryption key. In this case, the intermediary web site manually logs the data for the transaction based on information contained in the code (which identifies the third party originator of the body scan) and what product/service provider is requesting the decryption key.

According to some embodiments of the present invention, the intermediary negotiates and sells decryption keys in bulk to the product/service providers. The intermediary accumulates the transaction data on its web site over time and intermittently (i.e., monthly, quarterly) transmits a portion of the funds to the third party corresponding to the data usage logged on the intermediary's web site. As such, the intermediary provides “post purchase” financial incentives to the purchasers of body measurement systems. These incentives are combined with optional up-front financial incentives to the third parties via scanner pricing promotions for agreeing to participate in the network. In addition, product/service providers are presented with increased on-line sales opportunities.

### BRIEF DESCRIPTION OF THE DRAWINGS

The accompanying drawings, which form a part of the specification, illustrate embodiments of the present invention. The drawings and description together serve to fully explain the invention.

FIG. 1 is a perspective view of a typical body measurement system that can be utilized to generate body scan data in accordance with some embodiments of the present invention.

FIG. 2 is a schematic illustration of a camera and projector used by the system of FIG. 1.

FIG. 3 illustrates exemplary grating projections on the body of a subject produced by a projector of the body measurement system of FIG. 1.

FIG. 4 illustrates an anonymous body scan data sharing network, according to some embodiments of the present invention.

FIG. 5A is an exemplary web page from a web site of an intermediary, according to some embodiments of the present invention.

FIG. 5B illustrates links on the illustrated web page of FIG. 5A.

FIG. 6 is a flow chart that illustrates operations of an anonymous body scan data sharing network, according to some embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. All publications, patent applications, patents, and other references mentioned herein are incorporated herein by reference in their entirety. As used herein, the term “and/or” includes any and all combinations of one or more of the associated listed items.

The present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. However, software embodiments of the present invention do not depend on implementation with a particular programming language. It will be further appreciated that the functionality of any or all of the program modules may also be implemented using discrete hardware components, one or more application specific integrated circuits (ASICs), or a programmed digital signal processor or microcontroller.

The present invention is described below with reference to block diagram and flowchart illustrations of methods, apparatus (systems) and computer program products according to embodiments of the invention. It will be understood that each block of the block diagrams and/or flowchart illustrations, and combinations of blocks, can be implemented by computer program instructions and/or hardware operations. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process or method such that the instructions which execute on the computer or other programmable apparatus provide steps for implementing the functions specified in the block diagram and/or flowchart block or blocks.

It should be noted that, in some alternative embodiments of the present invention, the functions noted in the blocks may occur out of the order noted in the figures. For example, two blocks shown in succession may in fact be executed substantially concurrently or the blocks may sometimes be executed in the reverse order, depending on the functionality involved. Furthermore, in certain embodiments of the present invention, such as object oriented programming embodiments, the sequential nature of the flowcharts may be replaced with an object model such that operations and/or functions may be performed in parallel or sequentially.

### Obtaining Body Scan Data

Initially, an individual visits a business (e.g., a clothing retailer) location having a body measurement system configured to measure the surface contour of the body of the individual and generate a three-dimensional digital data set, referred to hereinafter as “body scan data.” Exemplary body measurement systems that may be used to generate body scan data, according to embodiments of the present invention, include those described in U.S. Pat. Nos. 5,953,448 and 6,373,963, and include those available from Textile/Clothing Technology-Corporation, Cary, N.C. (e.g., NX-12 White Light 3D Body Scanner, etc.). However, various types of body measurement systems that generate body scan data may be utilized in accordance with embodiments of the present invention, without limitation.

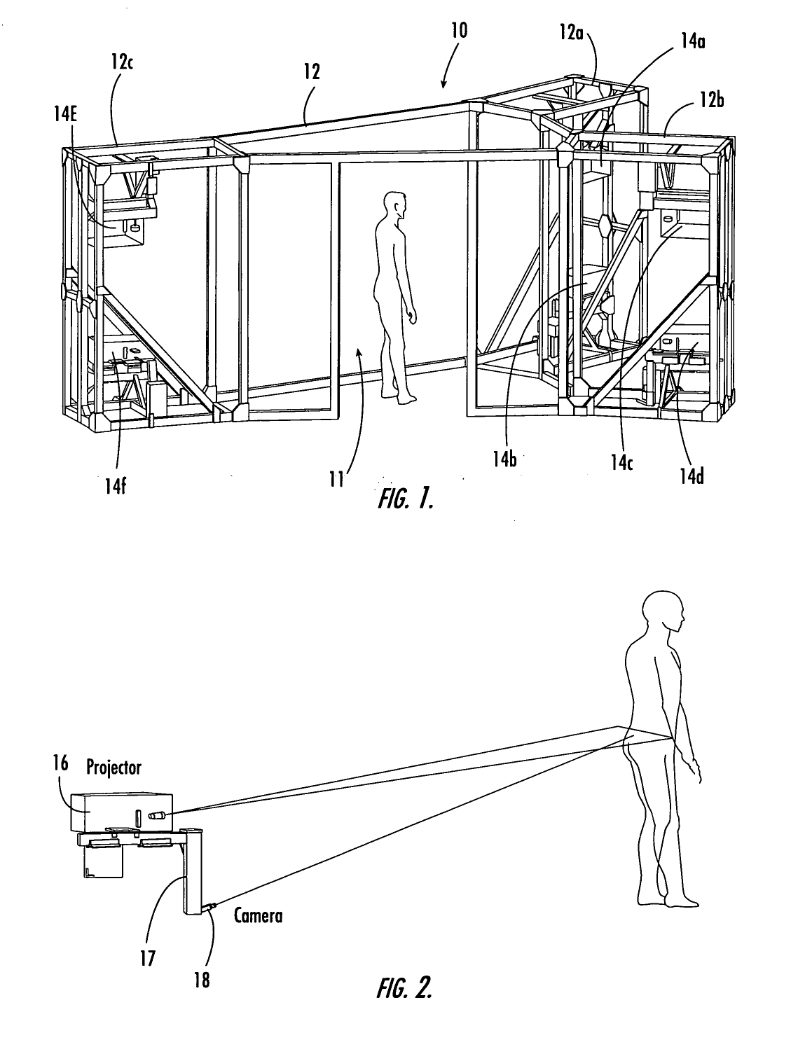

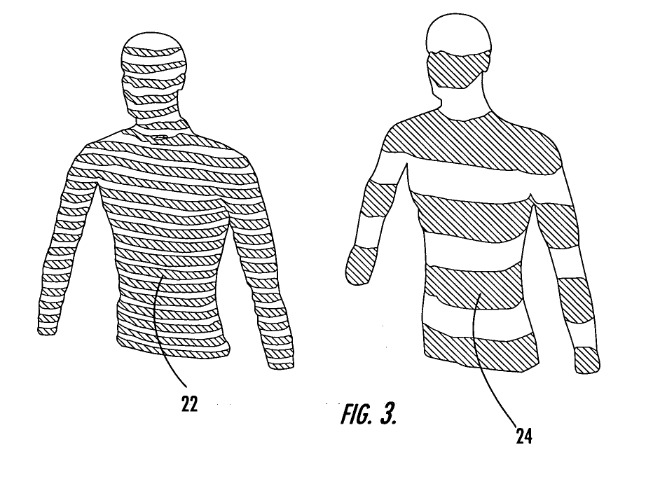

An exemplary body measurement system, designated broadly at 10, is illustrated in FIGS. 1-2. The system 10 includes a scanning chamber 11, a series of six sensors 14a, 14b, 14c, 14d, 14e, 14f, and a controller (not shown). The illustrated scanning chamber 11 includes a generally Y-shaped frame 12. The frame has two forward compartments 12a, 12b that are located in the “arms” of the “Y”, and a rear compartment 12c located in the “tail” of the “Y”. The sensors 14a, 14b are mounted in the forward compartment 12a, the sensors 14c, 14d are mounted in the forward compartment 12b, and the sensors 14e, 14f are mounted in the rear compartment 12c.

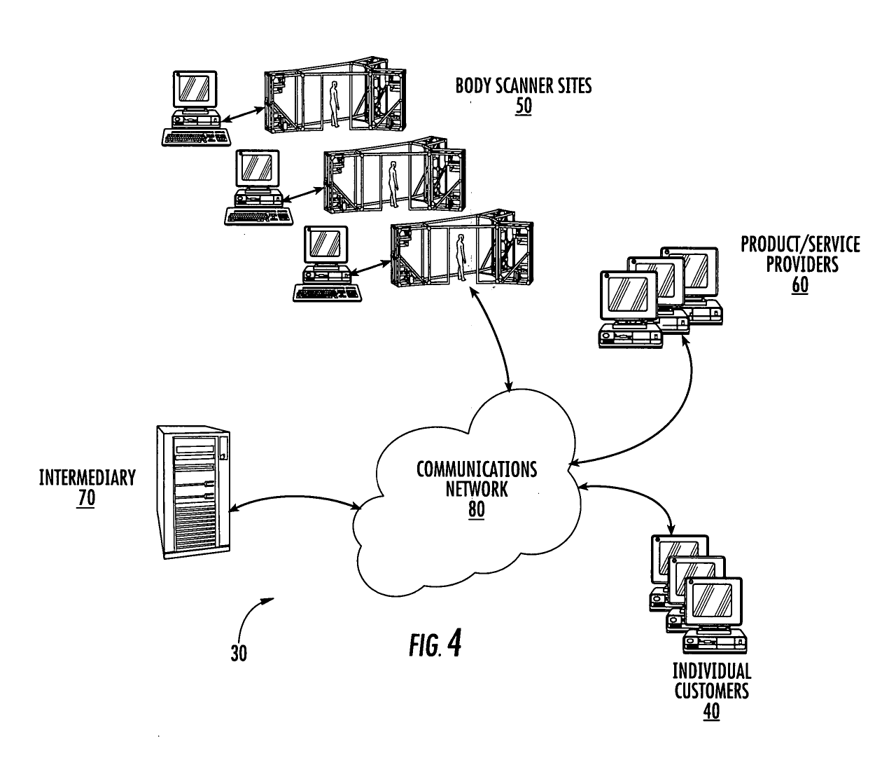

Each sensor includes a projector 16 and a camera (e.g., a charge coupled device (CCD)) 18 mounted on a frame 17 (FIG. 2). Each camera 18 detects the projected pattern on the occupant and provides a signal corresponding to the image to a controller 20. Each projector 16 includes one or more gratings (not shown), the image of which can be projected onto an occupant of the chamber 11. For example, a fine grating (e.g., 1 mm at the grating) can be used to produce a fine grating pattern 22 on the occupant (see FIG. 3); and a coarse grating (e.g., 5 mm at the grating) can be used to produce a coarse grating pattern 24 on the occupant (again, see FIG. 3). In either instance, the grating pattern varies in intensity sinusoidally in the vertical direction and is invariant in the horizontal direction.

Each projector 16 and camera 18 are mounted rigidly on a frame 17, which in turn is mounted in the frame 12, with each camera 18 being mounted below a respective projector 16. In this configuration, each camera 18 and projector 16 are separated by a baseline and thus form a triangulation with the occupant (see FIG. 2) that enables the distance to the projected image to be calculated.

Referring back to FIG. 1, the sensor 14a is mounted directly above the sensor 14b in the forward compartment 12a; similarly, the sensor 14c is mounted above the sensor 14d in the forward compartment 12b, and the sensor 14e is mounted above the sensor 14f in the rear compartment 12c. In this arrangement, an upper and lower image can be obtained from each compartment to achieve total height coverage.

All of the sensors 14a-14f are operatively connected to a controller that typically includes a motion control card and frame grabber circuit boards. The controller is connected to both the projector 16 (to control the timing of projection) and to the camera 18 (to retrieve image data gathered by the camera 18) of each of the sensors 14a-14f. The controller includes software that is configured to perform the following functions: providing a graphical user interface; controlling the data acquisition sequence; acquiring and storing image buffers; processing acquired images; calculating the resulting data points; displaying graphical output; and generating digital body scan data for an individual.

According to some embodiments of the present invention, the body scan data generated by a body measurement system for an individual may optionally be stored or maintained at the location of the body measurement system or by the owner of the body measurement system provided that they have the authorization of the customer. A copy of the body scan data is transferred to the individual, preferably within a predefined time period, such as, for example, twenty four hours. The individual may be provided with a storage media (e.g., floppy disk, CD-ROM, DVD, tape, etc) containing the body scan data. Alternatively, the body scan data may be emailed to the individual. As would be understood by those skilled in the art, the body scan data for an individual can be compressed to reduce the size of the data. In addition, the body scan data can be encrypted to ensure privacy. As will be described below, an intermediary retains a decryption key for all sets of body scan data generated by body measurement systems manufactured or sold or leased by the intermediary. However, the intermediary does not physically possess or have access to the body scan data of any individual, unless they themselves provide products/services directly to the customers, and the individual customers specifically send the body scan data to them in order to receive that product or service, or if the individual specifically authorizes the intermediary to retain the data along with rich identification information.

According to some embodiments of the present invention, the body scan data conveyed to an individual will also contain an identifier of the body measurement system (e.g., a serial number so that the intermediary can identify which third party generated particular body scan data) and an identifier of the location of the body measurement system. The body scan data conveyed to an individual may also contain information as to the date the body scan was taken.

### Anonymous Body Scan Data Sharing Network

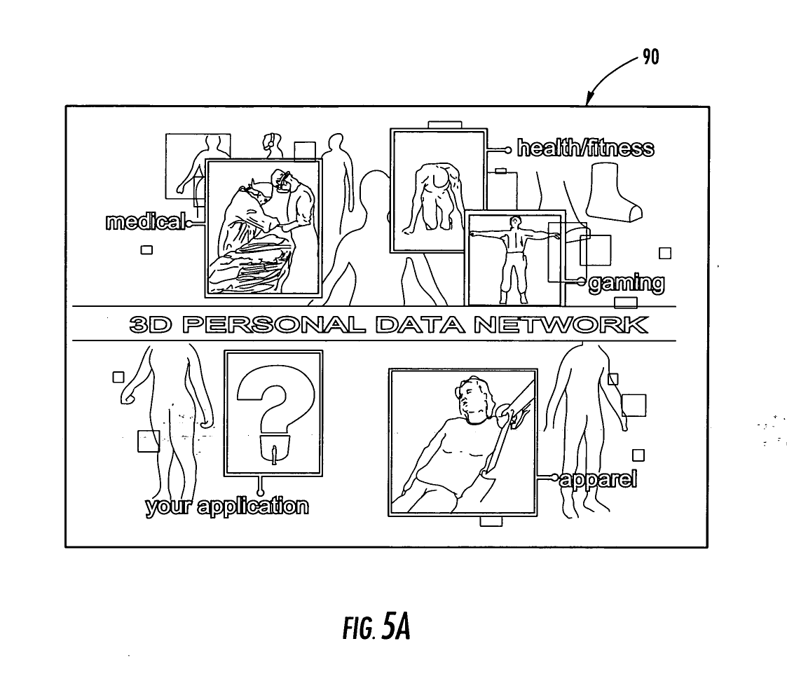

Referring to FIG. 4, an anonymous body scan data sharing network 30, according to embodiments of the present invention, is illustrated. The data sharing network 30 is designed to increase sales of body measurement systems sold by the intermediary, and to increase the number of product/service providers using body scan data generated by body measurement systems. As used herein, the term “intermediary” refers to a manufacturer of body measurement systems (e.g., body scanners, etc.); to an entity which otherwise controls the distribution of body scanners; and to an entity which owns the right to control the network via a business agreement. An intermediary may have relationships with other manufacturers of body measurement systems, as well. The data sharing network 30 is also designed to generate revenue for the intermediary based on network transactions, and to generate compensatory revenue for a body scan provider whose customer ultimately may use their body scan to procure products and services from their competitors.

The illustrated data sharing network 30 includes a plurality of individual customers 40, a plurality of third parties having body measurement systems (“third party body scanner sites”) 50, a plurality of product/service providers 60, and an intermediary web site 70, all in communication with each other via a communications network 80, such as the Internet, for example. The intermediary may also operate as a third party, providing body scans and/or products and services.

As used herein, the term “customer” refers to an individual who has obtained body scan data for herself or himself and who uses this body scan data to purchase various goods and/or services. The term “product/service provider” refers to any provider of products and/or services that a customer may obtain and with the body scan data of the customer.

As is known to those skilled in this art, the Internet is a worldwide decentralized network of computers having the ability to communicate with each other. The World-Wide Web (web) is comprised of server-hosting computers (web servers) connected to the Internet that have hypertext documents (referred to as web pages) stored therewithin. Web pages are accessible by client programs, referred to as “web clients”, (e.g., web browsers) utilizing the Hypertext Transfer Protocol (HTTP) via a Transmission Control Protocol/Internet Protocol (TCP/IP) connection between a client-hosting device and a server-hosting device. While HTTP and web pages are the prevalent forms for the web, the web itself refers to a wide range of protocols including Secure Hypertext Transfer Protocol (HTTPS) and File Transfer Protocol (FTP), and web content formats including plain text, HyperText Markup Language (HTML), Extensible Markup Language (XML), as well as image formats such as Graphics Interchange Format (GIF) and Joint Photographic Experts Group (JPEG).

A web site is conventionally a related collection of web files that includes a beginning file called a “home” page. From the home page, a visitor can access other files and applications at a web site. A large web site may utilize a number of servers, which may or may not be different and which may or may not be geographically-dispersed. The term “web site”, as used herein, shall include FTP sites.

A web server (also referred to as an HTTP server) is a computer program that utilizes HTTP to serve files that form web pages to requesting web clients. Exemplary web servers include International Business Machines Corporation's family of Lotus Domino® servers, the Apache server (available from www.apache.org), and Microsoft's Internet Information Server (IIS), available from Microsoft Corporation, Redmond, Wash. A web client is a requesting program that also utilizes HTTP. A browser is an exemplary web client for use in requesting web pages and files from web servers. A web server waits for a web client, such as a browser, to open a connection and to request a specific web page or application. The web server then sends a copy of the requested item to the web client, closes the connection with the web client, and waits for the next connection.

HTTP allows a browser to request a specific item, which a web server then returns and the browser renders. To ensure that browsers and web servers can interoperate unambiguously, HTTP defines the exact format of requests (HTTP requests) sent from a browser to a web server as well as the format of responses (HTTP responses) that a web server returns to a browser. Exemplary browsers that can be utilized with embodiments of the present invention include, but are not limited to, Mozilla Firefox™ (The Mozilla Foundation, Mountain View, Calif.) and Internet Explorer™ (Microsoft Corporation, Redmond, Wash.). Browsers typically provide a graphical user interface for retrieving and viewing web pages, applications, and other resources served by web servers.

As is known to those skilled in this art, a web page is conventionally formatted via a standard page description language such as HTML, which typically contains text and can reference graphics, sound, animation, and video data. HTML provides for basic document formatting and allows a web content provider to specify anchors or hypertext links (typically manifested as highlighted text) to other servers. When a user selects a particular hypertext link, a browser running on the user's client device reads and interprets an address, called a Uniform Resource Locator (URL) associated with the link, connects the browser with a web server at that address, and makes a request (e.g., an HTTP request) for the file identified in the link. The web server then sends the requested file to the client device which the browser interprets and renders within a display screen.

Still referring to FIG. 4, the intermediary is the manufacturer and seller of body measurement systems used by the various third party body scanner sites 50. Body scanner sites 50 that agree to participate in the data sharing network 30 receive various benefits including, but not limited to, pricing concessions on body measurement systems purchased or leased from the intermediary, and a percentage of revenue generated by the network 30 as a result of use of customer body scan data.

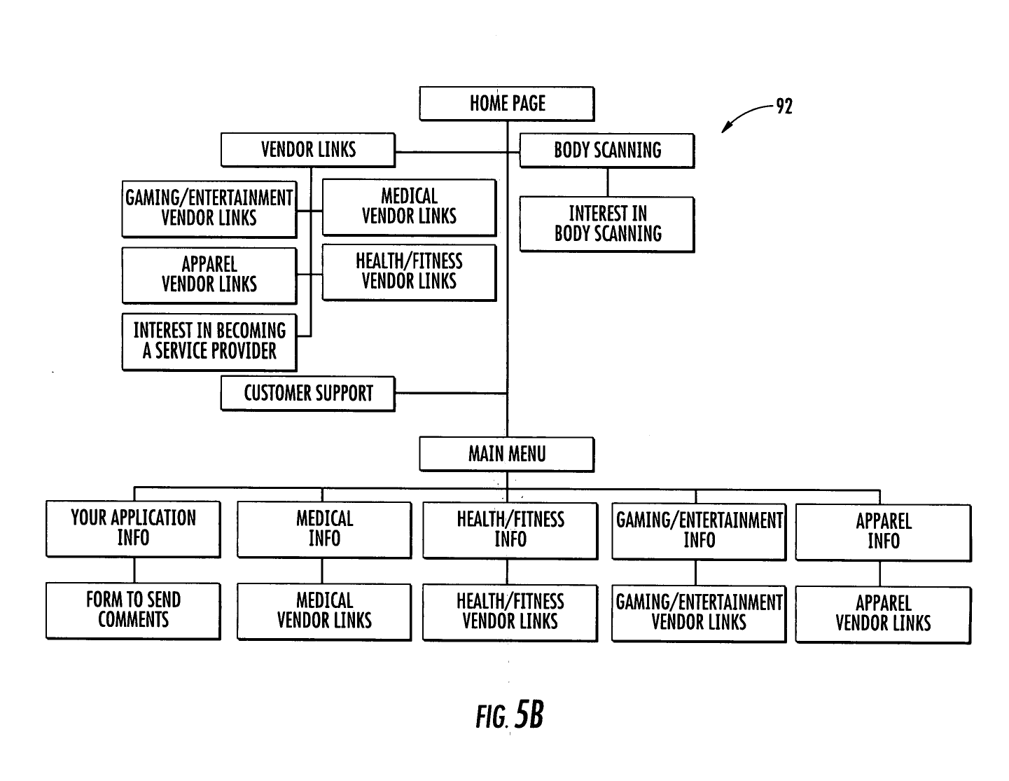

According to embodiments of the present invention, an individual customer 40 who has already received his/her body scan data from the body measurement system of a third party body scanner site 50 accesses the intermediary web site 70 in search of product/service providers 60 who utilize body scan data in providing products and services. For example, a customer may be interested in various clothing retailers that will utilize body scan data for the customer to prepare custom-tailored clothing. The intermediary web site 70 displays links to various product/service providers 60 who are participating in the network 30. FIG. 5A is an exemplary web page 90 from the intermediary web site 70, and FIG. 5B illustrates a hierarchical structure of links 92 on the illustrated web page 90 of FIG. 5A. Various numbers and types of web pages may be displayed via the intermediary web site 70. Embodiments of the present invention are not limited to the illustrated web page 90 and link hierarchical structure 92.

Upon activating a link at the intermediary web site 70, an individual customer is redirected to the web site of a respective product/service provider 60. Exemplary product/service providers 60 may include clothing retailers, physical fitness centers, etc. A product/service provider may have a body measurement system, but need not. In other words, a product/service provider 60 may also be a third party body scanner site 50. Moreover, a product/service provider may have a body measurement system, but this body measurement system may not be the particular system utilized to generate the body scan data for this particular individual.

According to some embodiments of the present invention, each product/service provider 60 may pay a subscription fee to the intermediary 70 for participating in the network 30. According to some embodiments of the present invention, each product/service provider 60 pays the intermediary 70 for a set of decryption keys that allow access to body scan data provided by a predetermined number of individuals.

If a customer 40 chooses to purchase a product or service from a particular product/service provider 60, the customer transmits his/her body scan data directly to the particular product/service provider 60 via the network 80. For example, the customer may send the body scan data to the product/service provider 60 via an email or via FTP to the product/service provider's web site. The product/service provider 60 decrypts the body scan data via a decryption key purchased from the intermediary 70. A log file is automatically generated by the software provided by the intermediary to the product/service provider 60 when a decryption key is requested from the intermediary web site 70 by a product/service provider 60. The log file registers the transaction from data that is contained in the request for a decryption key from the product/service provider 60.

According to some embodiments of the present invention, the intermediary 70 sells decryption keys to the various product/service providers 60 and each key is valid for decrypting the body scan data for a particular customer 40. Accordingly, the product/service providers 60 will need to purchase additional decryption keys over time from the intermediary 70 as the number of customers 40 increases. According to embodiments of the present invention, when a product/service provider 60 runs out of decryption keys, it purchases more from the intermediary via the network 60.

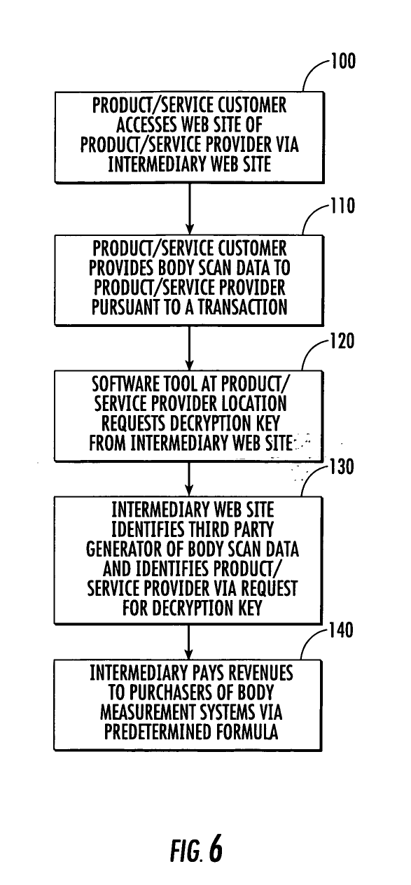

Referring now to FIG. 6, a flow chart of systems, methods and/or computer program products for utilizing the body scan data sharing network 30 of FIG. 4, according to some embodiments of the present invention, are illustrated. Operations represented by FIG. 6 may be implemented manually, may be implemented via one or more computers, or may be implemented via a combination of manual and computer operations.

A product/service customer 40, for example via a browser, accesses the web site of a product/service provider 60 through a link from the intermediary web site 70 (Block 100). Alternatively, if the customer knows the web site URL of a particular product/service provider, the customer may go directly to this web site without accessing the intermediary web site. The product/service customer 40 provides his/her body scan data to the product/service provider pursuant to a transaction (Block 110). For example, if the product/service provider 60 is a clothing retailer and the product/service customer 40 wishes to purchase a pair of pants from the product/service provider 60, the product/service customer 40 provides his body scan data to the product/service provider 60 so that the pants can be appropriately sized to fit the product/service customer 40.

A software tool provided to each product/service provider 60 by an intermediary, requests a decryption key from the intermediary web site 70 in response to receiving body scan data from a customer (Block 120). After receiving a decryption key from the intermediary web site, the product/service provider 60 utilizes the product/service customer's body scan data to execute a transaction (e.g., to correctly manufacture or select an article of clothing, etc.).

Using information in the decryption key request, the intermediary web site 70 identifies both who generated the body scan data and who the product/service provider is (Block 130). The intermediary then pays revenues to the various third party body scan sites 50 according to a predetermined formula and/or business arrangement (Block 140).

Many variations and modifications can be made to the preferred embodiments without substantially departing from the principles of the present invention. All such variations and modifications are intended to be included herein within the scope of the present invention, as set forth in the following claims.

That which is claimed is:

1. A method of buying products/services via a network, wherein the network comprises a web site of an intermediary and a web site of a product/service provider, and wherein a customer communicates with the intermediary web site and product/service provider web site via a web client, the method comprising the following steps performed by the customer:
accessing the product/service provider web site via the web client;
initiating a purchase transaction with the product/service provider, wherein the purchase transaction requires body scan data for the customer; and
transmitting customer body scan data to the product/service provider.

2. The method of claim 1, wherein accessing the product/service provider web site comprises:
accessing the intermediary web site via the web client; and
activating a link at the intermediary web site that redirects the web client to the product/service provider web site.

3. The method of claim 1, wherein initiating a purchase transaction and transmitting customer body scan data are performed via the web client.

4. The method of claim 1, wherein initiating a purchase transaction comprises initiating a purchase transaction via telephone.

5. The method of claim 3, wherein initiating a purchase transaction and transmitting customer body scan data are performed substantially simultaneously via the web client.

6. The method of claim 1, wherein the step of initiating a purchase transaction is preceded by the step of transmitting customer body scan data to the product/service provider.

7. The method of claim 1, wherein customer body scan data is transmitted to the product/service provider via email.

8. The method of claim 1, wherein the product/service provider is selected from the group consisting of: clothing retailers, health/fitness product/service providers, gaming product/service providers, and entertainment product/service providers.

9. The method of claim 1, wherein transmitting customer body scan data to the product/service provider comprises transmitting the customer body scan data in encrypted format.

10. A method of selling products/services via a network, wherein the network comprises a web site of an intermediary and a web site of a product/service provider, and wherein a customer communicates with the intermediary web site and product/service provider web site via a web client, the method comprising the following steps performed by the product/service provider:
conducting a sales transaction with the customer in response to receiving body scan data from the customer;
obtaining a decryption key from the intermediary web site, wherein the decryption key is configured to decrypt the body scan data received from the customer; and
decrypting the body scan data via the decryption key.

11. The method of claim 10, wherein obtaining a decryption key from the intermediary web site comprises purchasing the decryption key from the intermediary.

12. A method of buying and selling products/services via a network, wherein the network comprises a web site of an intermediary and a web site of a product/service provider, and wherein a customer communicates with the intermediary web site and product/service provider web site via a web client, the method comprising the following performed by the intermediary:
receiving a request for a body scan data decryption key from a product/service provider in connection with a sales transaction between a customer and the product/service provider;
identifying a third party that generated body scan data for the customer participating in the sales transaction; and
transmitting funds to the identified third party.

13. A method of buying and selling products/services via a network, wherein the network comprises a web site of an intermediary and a web site of a product/service provider, and wherein a customer communicates with the intermediary web site and product/service provider web site via a web client, the method comprising:
receiving an offer at a product/service provider web site from a customer to purchase a product/service from the product/service provider, wherein the offer includes body scan data of the customer in encrypted format;
receiving a request at an intermediary web site from the product/service provider for a body scan data decryption key in connection with the purchase offer by the customer;
identifying a third party that generated the body scan data for the customer participating in the sales transaction; and
transmitting funds to the third party in response to receiving the sales transaction record from the product/service provider.

14. An on-line system for buying and selling products and services, comprising:
a communications network;
a web site of an intermediary in communication with the network;
a plurality of web sites of product/service providers in communication with the network; and
a customer in communication with the network via a web client, wherein the customer web client is configured to access a product/service provider web site, initiate a purchase transaction with the product/service provider, and transmit customer body scan data to the product/service provider, wherein the customer body scan data is encrypted and includes an identification of a third party that generated the body scan data for the customer.

15. The system of claim 14, wherein each product/service provider web site is configured to conduct a sales transaction with a customer in response to receiving body scan data from the customer and to request a decryption key from the intermediary web site.

16. The system of claim 15, wherein the intermediary web site is configured to transmit funds to the third party that generated body scan data for the customer in response to receiving the decryption key request from the product/service provider.

17. The system of claim 14, further comprising a body scan data generator in communication with the network, comprising:
a projector that projects a beam of light having a sinusoidally varying intensity pattern onto an object; and
a sensor that receives and stores a deformed grating image of the object for a plurality of phase shifts of the beam of light, wherein the image comprises an array of pixels.

18. The system of claim 14, further comprising a body scan data generator in communication with the network, comprising a video silhouette generator of body scan data.

19. The system of claim 14, further comprising a body scan data generator in communication with the network, comprising a laser based body scan generator.

20. The system of claim 14, further comprising a body scan data generator in communication with the network, comprising a white-light based 3D scan system.

21. The system of claim 14, wherein the customer web client is configured to transmit customer body scan data to the product/service provider via email.

22. The system of claim 14, wherein the customer web client is configured to transmit customer body scan data to the product/service provider in encrypted format.

23. The system of claim 14, wherein the product/service provider is selected from the group consisting of: clothing retailers, health/fitness product/service providers, gaming product/service providers, and entertainment product/service providers.

24. The system of claim 15, wherein each product/service provider web site is configured to decrypt body scan data via an obtained decryption key.

25. A computer program product for buying products/services via a network, wherein the network comprises a web site of an intermediary and a web site of a product/service provider, and wherein a customer communicates with the intermediary web site and product/service provider web site via a web client, comprising:
a computer readable storage medium having computer readable program code embodied therein, the computer readable program code being configured to carry out the method of claim 1.

26. A computer program product for selling products/services via a network, wherein the network comprises a web site of an intermediary and a web site of a product/service provider, and wherein a customer communicates with the intermediary web site and product/service provider web site via a web client, comprising:
a computer readable storage medium having computer readable program code embodied therein, the computer readable program code being configured to carry out the method of claim 10.

27. A computer program product for buying and selling products/services via a network, wherein the network comprises a web site of an intermediary and a web site of a product/service provider, and wherein a customer communicates with the intermediary web site and product/service provider web site via a web client, comprising:
a computer readable storage medium having computer readable program code embodied therein, the computer readable program code being configured to carry out the method of claim 12.

28. A computer program product for buying and selling products/services via a network, wherein the network comprises a web site of an intermediary and a web site of a product/service provider, and wherein a customer communicates with the intermediary web site and product/service provider web site via a web client, comprising:
a computer readable storage medium having computer readable program code embodied therein, the computer readable program code being configured to carry out the method of claim 13.
